(19) United States
(12) Patent Application Publication
(10) Pub. No.: US 2017/0289672 A1
(43) Pub. Date: Oct. 5, 2017

(54) SPEAKER MODULE

(71) Applicant: GOERTEK INC., WeiFang (CN)

(72) Inventors: Xinfeng YANG, WeiFang (CN); Tongyan XU, WeiFang (CN); Pengcheng JI, WeiFang (CN)

(21) Appl. No.: 15/507,981

(22) PCT Filed: Nov. 5, 2014
(86) PCT No.: PCT/CN2014/090338

§ 371 Date: Mar. 1, 2017

(30) Foreign Application Priority Data
Sep. 1, 2014 (CN) 201410440182.4

(51) Int. Cl. H04R 1/22; H04R 1/02; H04R 9/06

(52) U.S. Cl. CPC H04R 1/22; H04R 9/06; H04R 1/025

(57) ABSTRACT

Disclosed is a speaker module comprising a housing in which a speaker unit is accommodated; the interior cavity of the module is divided into a front acoustic cavity and a rear acoustic cavity by the speaker unit; a sound absorbing material is provided in the rear acoustic cavity; the rear acoustic cavity is provided with a partition member for isolating the sound absorbing material and the speaker unit; the entire rear acoustic cavity is divided into a filled region and a non-filled region by the partition member; the sound absorbing material is located in the filled region; the material of the sound absorbing material is foaming material; and the sound absorbing material is formed by foaming the foaming material and fills the filled region. The speaker module provided by the present invention has good acoustic performance, high production efficiency, low production costs and good uniformity of product.

### TECHNICAL FIELD

The present invention relates to the technical field of electro-acoustic products, specifically, to a speaker module.

### BACKGROUND ART

The speaker module is an important acoustic component of a portable electronic apparatus, and is used for implementing conversion between an electronic signal and a sound signal, and the speaker module is an energy conversion device. Prior speaker module typically comprises a housing in which a speaker unit is accommodated, and the entire interior cavity of the module is divided into a front acoustic cavity and a rear acoustic cavity by the speaker unit. In order to decrease F0 (low frequency) of the module and broaden the bandwidth of the module, a sound-absorbing cotton is typically added to the rear acoustic cavity by those skilled in the art, the sound-absorbing cotton can decrease F0 of the module effectively, allow the medium frequency curve to be more smooth, and thus the sound-absorbing cotton is an important component in the speaker module. As the extent of the effect of the sound-absorbing cotton in the rear acoustic cavity is directly associated with the filling volume of the sound-absorbing cotton in the rear acoustic cavity, it is advantageous to performance improvement of the speaker module that the sound-absorbing cotton fills the rear acoustic cavity as much as possible.

Rear acoustic cavities of speaker modules in the prior art typically have irregular shapes. However, the existing sound-absorbing cotton has a constant thickness, in order to fill the irregular rear acoustic cavity with the sound-absorbing cotton having a constant thickness, the adaptability of the sound-absorbing cotton with the rear acoustic cavity can only be achieved by adhering and combining a plurality pieces of sound-absorbing cotton, which makes it difficult to control the fitness of the sound-absorbing cotton and the housing, compression ratio of the sound-absorbing cotton and the like, as a result, the uniformity of the module is poor; and it can only be performed manually, and has disadvantages of high labor intensity and high operating difficulty, which results in high labor cost and high production costs of products, and low production efficiency.

### SUMMARY

The technical problem sought to be solved by the present invention is to provide a speaker module, the sound absorbing material of the speaker module can fit the rear acoustic cavity perfectly, and thus the product has good consistency, low cost and high production efficiency.

In order to solve the above technical problem, the technical solution of the present invention is:

a speaker module comprising a housing in which a speaker unit is accommodated, wherein the speaker unit comprises a vibration system and a magnetic circuit system, the entire interior cavity of the speaker module is divided into a front acoustic cavity and a rear acoustic cavity by the speaker unit, and a sound absorbing material is provided in the rear acoustic cavity, wherein a partition member for isolating the sound absorbing material from the speaker unit is provided in the rear acoustic cavity, the entire rear acoustic cavity is divided into a filled region and a non-filled region by the partition member; the sound absorbing material is located in the filled region, the sound absorbing material is made of foaming material, the sound absorbing material is formed by foaming the foaming material, and the sound absorbing material fills up the filled region.

Wherein, the partition member is provided with a hole which allows airflow to flow between the filled region and the non-filled region.

Wherein, the partition member has a netted structure.

Wherein, the foaming material is PU, DWT, or melamine.

Wherein, the foaming material is foamed through heating process, ultrasonic process or infrared radiation process to form the sound absorbing material.

As one implementation, the housing comprises a first housing, a second housing, and a third housing which are combined together, the rear acoustic cavity is defined by the speaker unit, the second housing and the third housing, and the partition member is vertically provided between the second housing and the third housing.

Wherein, a cross section of the filled region has a Chinese character “ [symbol] ”-like shape, that is, a height of a middle part of the cross section is higher than heights of both sides of the cross section; and the sound absorbing material has a shape corresponding to that of the filled region, and the sound absorbing material fills up the entire filled region.

Wherein, the magnetic circuit system comprises a yoke fixed on the second housing, an inner magnet and an inner washer are sequentially arranged at the middle part of the interior side of the yoke, an outer magnet and an outer washer are sequentially arranged at the edge part of the interior side of the yoke, a locating recess formed by material removal is provided at one side of the outer washer closer to the second housing, a locating boss at the position opposite to the locating recess is provided on an interior wall of the second housing, and the locating boss is coupled with the locating recess.

As another implementation, the housing comprises a first housing and a second housing which are combined together, the rear acoustic cavity is defined by the speaker unit, the first housing and the second housing, and the partition member is vertically provided between the first housing and the second housing.

Wherein, grooves respectively extending upwardly and downwardly are provided at the upper end and lower end of the filled region, respectively, each of the grooves is a triangular groove which has a relatively wide opening and a sharp bottom, the sound absorbing material has a shape corresponding to that of the filled region, and the sound absorbing material fills up all of the grooves.

As one implementation, the foaming material is solid material, and the rear acoustic cavity is sealed after the foaming material is arranged in the filled region.

As another implementation, the foaming material is liquid material, and the foaming material is injected into the filled region through an injecting hole of the rear acoustic cavity after the rear acoustic cavity is sealed.

With the above technical solution, the present invention achieves the following effects:

In the speaker module of the present invention, as a sound absorbing material is provided in the rear acoustic cavity, and a partition member is further provided, the rear acoustic cavity is divided into a filled region and a non-filled region by the partition member. The sound absorbing material is located in the filled region, and the sound absorbing material is formed by foaming the foaming material and fills the filled region. During assembly of the module, the foaming material is arranged in the rear acoustic cavity of the module, and then is foamed and expanded through a process such as a heating or ultrasonic process, so as to fill the entire filled region of the rear acoustic cavity. The partition member acts as a barrier which can prevent the foaming material from being expanded into the speaker unit during foaming and from impacting the performance of the speaker unit. The sound absorbing material formed by foaming the foaming material can completely fit the housing defining the rear acoustic cavity, make full use of the space of the rear acoustic cavity, decrease F0 of the module substantially, enable a wider band of the module, make the medium frequency curve more smooth, and enable better acoustic performance of the module. Meanwhile, the sound absorbing material prepared through foaming does not require manual work, thereby decreasing the number of the workers substantially, saving the labor and cost, and improving the production efficiency. Besides, the sound absorbing material can fit the rear acoustic cavity of the speaker module perfectly, and thus the product has good uniformity.

In conclusion, with the speaker module provided by the present invention, technical problems such as poor uniformity and high production costs of speaker module products in prior art are solved. The speaker module provided by the present invention has good acoustic performance, high production efficiency, low production costs and good uniformity of products.

### BRIEF DESCRIPTION OF THE DRAWINGS

FIG. 1 is a three-dimensional structure exploded view of embodiment 1 of the speaker module according to the present invention, wherein the first housing is not included;

FIG. 2 is a sectional structure view of embodiment 1 of the speaker module according to the present invention;

FIG. 3 is a sectional structure view of embodiment 2 of the speaker module according to the present invention;

FIG. 4 is a structure view of embodiment 2 of the speaker module according to the present invention, wherein the first housing is not installed;

FIG. 5 is a structure exploded view of the sound absorbing material and the second housing of embodiment 2 of the speaker module according to the present invention;

FIG. 6 is a structure view of the cross section of one sound absorbing material processed through a foaming process;

FIG. 7 is a structure view of the cross section of another sound absorbing material processed through a foaming process;

FIG. 8 is a structure view of the cross section of still another sound absorbing material processed through a foaming process;

In the drawings: 10a: first housing; 10b: first housing; 12: sound hole; 20a: second housing; 20b: second housing; 22: ultrasonic wire; 30a: third housing; 40a: speaker unit; 40b: speaker unit; 41: dome; 42: vibrating diaphragm; 43: voice coil; 44: yoke; 45: inner magnet; 46: outer magnet; 47: inner washer; 48: outer washer; 49: backing ring; 50a: sound absorbing material; 50b: sound absorbing material; 60a: partition member; 60b: partition member.

### DETAILED DESCRIPTION OF EMBODIMENTS

The present invention will be further described below in conjunction with the accompanying drawings and embodiments.

The upper orientation involved in the present specification refers to the direction of the vibration system of the speaker unit, while the lower orientation refers to the direction of the magnetic circuit system of the speaker unit. The interior side involved in the present specification refers to the side inside the interior cavity of the module or inside the interior cavity of the speaker unit, while the outer side refers to the side outside the interior cavity of the module or outside the interior cavity of the speaker unit.

### Embodiment 1

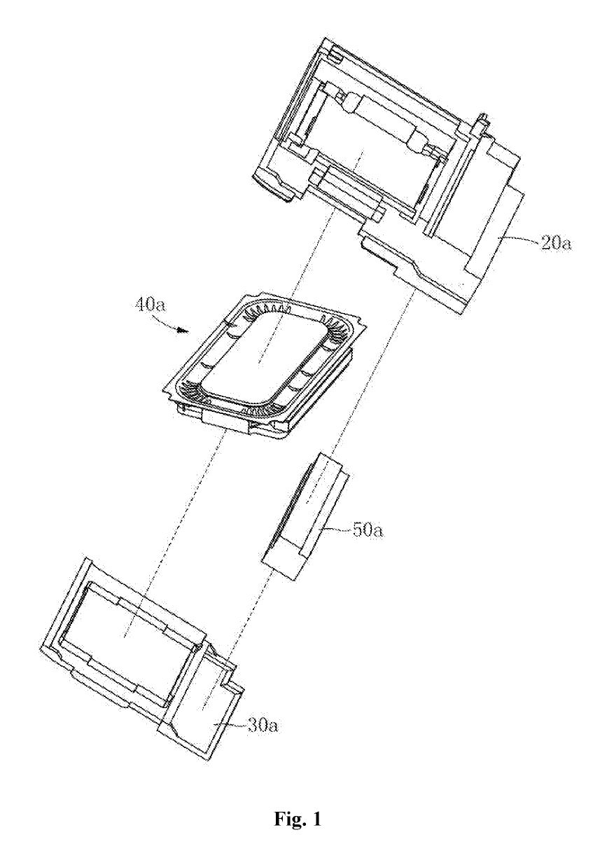

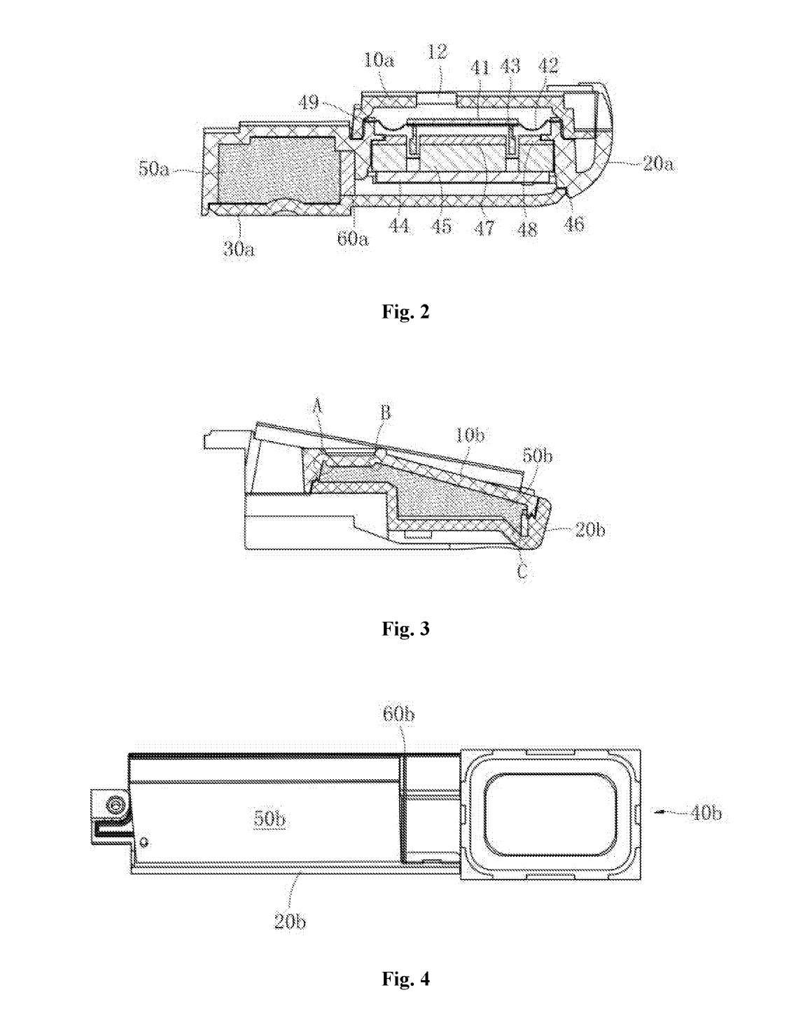

As shown in FIG. 1 and FIG. 2 together, a speaker module comprises a housing, the housing is constituted by a first housing 10a, a second housing 20a and a third housing 30a which are combined together, and the speaker unit 40a is accommodated in the space defined by the first housing 10a, the second housing 20a and the third housing 30a. The speaker unit 40a divides the entire interior cavity of the speaker module into two cavities, i.e., a front acoustic cavity and a rear acoustic cavity, wherein the front acoustic cavity is defined by the speaker unit 40a and the first housing 10a, a sound hole 12 is provided on the first housing 10a for sound radiation; the rear acoustic cavity is defined by the speaker unit 40a , the second housing 20a and the third housing 30a, a sound absorbing material 50a is provided in the rear acoustic cavity, and a partition member 60a for isolating the sound absorbing material 50a and the speaker unit 40a is further provided in the rear acoustic cavity. The partition member 60a is vertically provided between the second housing 20a and the third housing 30a, and the partition member divides the entire rear acoustic cavity into a filled region and a non-filled region. The partition member 60a is provided with a hole through which sound waves transmit between the filled region and the non-filled region. It is preferable in the present embodiment that the partition member 60a has a netted sheet structure, a sound absorbing material 50a is located in the filled region, and the lower part of the speaker unit 40a is located in the non-filled region. The partition member 60a is made of plastic or metal, and the partition member 60a can be coupled with the housing through injection molding or adhesive bonding.

As shown in FIG. 1 and FIG. 2 together, the material of the sound absorbing material 50a may be foaming material, the sound absorbing material 50a may be formed by foaming the foaming material, and the sound absorbing material 50a fills the filled region. The foaming material may comprise PU (Polyurethane), DWT (foaming sponge), melamine, or the like. The above foaming material is arranged in the filled region of the rear acoustic cavity during assembly of the module, and then the foaming material is foamed through a process, such as a heating, ultrasonic or infrared lamp irradiation process, and the foaming material fills the entire filled region of the rear acoustic cavity (seamless filling, perfect fit), thereby forming the sound absorbing material 50a fitting the rear acoustic cavity perfectly. The foaming material is not limited to the abovementioned materials, which are preferable materials in the present invention. In practical use, solid foaming materials can be used, and liquid foaming materials can be used as well. If the foaming material is a solid material, the foaming material is arranged in the filled region of the rear acoustic cavity before the rear acoustic cavity is sealed, and then the rear acoustic cavity is sealed. Then, the foaming material arranged in the filled region of the rear acoustic cavity is foamed through a foaming process, to enable volume expansion of the foaming material and fill the entire filled region of the rear acoustic cavity, thereby forming the sound absorbing material fitting the filled region of the rear acoustic cavity perfectly. If the foaming material is a liquid material, the rear acoustic cavity is sealed firstly, and then the foaming material is injected into the filled region of the rear acoustic cavity through the injecting hole of the rear acoustic cavity and the like. Then, the foaming material arranged in the filled region of the rear acoustic cavity is foamed through a foaming process, to enable volume expansion of the foaming material and fill the entire filled region of the rear acoustic cavity, thereby forming the sound absorbing material fitting the rear acoustic cavity perfectly. The forming process of the sound absorbing material formed by foaming the foaming material is simple and easy, and the sound absorbing material can perfectly fit the housing defining the rear acoustic cavity, thereby improving the acoustic performance of the module and the uniformity of the module substantially.

As shown in FIG. 2, the cross section of the filled region has a shape similar to the Chinese character “ [symbol] ”, that is, the filled region has a concave-convex structure at the top and a plane structure at the bottom. Thus, the height of the middle of the filled region is larger, and the heights of both sides of the filled region are smaller. The sound absorbing material 50a has the same structure as that of the filled region, fills the entire filled region, and perfectly fits the second housing 20a, the third housing 30a and the partition member 60a by which the filled region is defined, thereby making full use of the space of the rear acoustic cavity, decreasing F0 of the module substantially, increasing the frequency bandwidth of the module, and allowing the medium frequency curve of the module to be more smooth.

As shown in FIG. 2, the speaker unit 40a comprises a vibration system and a magnetic circuit system. The vibration system comprises a vibrating diaphragm 42, the edge portion of the vibrating diaphragm 42 is fixed on the end surface of the second housing 20a, and a backing ring 49 is fixed on the upper surface of the edge portion of the vibrating diaphragm 42. The backing ring 49 is used for enhancing the firmness of the vibrating diaphragm 42, so as to prevent the vibrating diaphragm 42 from getting off the second housing 20a during vibration. A dome 41 is fixed at the center position of one side of the vibrating diaphragm 42, wherein the one side is closer to the first housing 10a, and a voice coil 43 is fixed at the other side of the vibrating diaphragm 42. The magnetic circuit system comprises a yoke 44 fixed inside the second housing 20a, an inner magnet 45 and an inner washer 47 are successively arranged at the middle part of the interior side of the yoke 44, and an outer magnet 46 and an outer washer 48 are successively arranged at the edge part of the interior side of the yoke 44. The inner magnet 45 and the inner washer 47 constitute an inner magnetic circuit of the speaker unit, the outer magnet 46 and the outer washer 48 constitute an outer magnetic circuit of the speaker unit, there is a magnetic gap between the inner magnetic circuit and the outer magnetic circuit, and the lower end of the voice coil 43 is located in the magnetic gap. The voice coil 43 moves up and down in the magnetic gap according to the magnitudes and polarities of the electrical signals transmitting through the windings of the voice coil, and then as the voice coil 43 moves up and down, the vibrating diaphragm 42 vibrates to stir up air to generate sound, thereby converting energy between electricity and sound.

As shown in FIG. 2, one side of the outer washer 48 closer to the second housing 20a is provided with a locating recess formed by material removal, an interior wall of the second housing 20a is provided with a locating boss at the position opposite to the locating recess, and the locating boss is coupled with the locating recess. Such structure allows the contact area of the outer washer 48 and the second housing 20a to be enlarged, so as to improve the firmness of the bonding between the outer washer 48 and the second housing 20a, thereby effectively preventing the outer magnetic circuit from getting close to the inner magnetic circuit under magnetic field, and improving the stability of the product.

As shown in FIG. 2, there are more turns of windings and larger thickness at one end of the voice coil 43 which is away from the vibrating diaphragm 42 (that is, at one end in the magnetic gap), whereby the magnetic gap can be fully used, the acting force caused by magnetic field can be improved, and the sensitivity of the module can be improved.

### Embodiment 2

As shown in FIG. 3 and FIG. 4 together, a speaker module comprises a housing, the housing is constituted by a first housing 10b and a second housing 20b which are combined together. The speaker unit 40b is accommodated in the space defined by the first housing 10b and the second housing 20b. The entire interior cavity of the speaker module is divided into a front acoustic cavity and a rear acoustic cavity by the speaker unit 40b, wherein the rear acoustic cavity of the module is defined by the speaker unit 40b, the first housing 10b and the second housing 20b. A sound absorbing material 50b is provided in the rear acoustic cavity, and a partition member 60b for isolating the sound absorbing material 50b and the speaker unit 40b is further provided in the rear acoustic cavity. The partition member 60b is vertically provided between the first housing 10b and the second housing 20b, whereby the entire rear acoustic cavity is divided into a filled region and a non-filled region by the partition member 60b. The sound absorbing material 50b is located in the filled region, and the lower portion of the speaker unit 40b is located in the non-filled region.

As shown in FIG. 4, the structure and material of the partition member 60b in the present embodiment is the same as that of the partition member 60a (as shown in FIG. 2) in Embodiment 1, thus the related description is omitted.

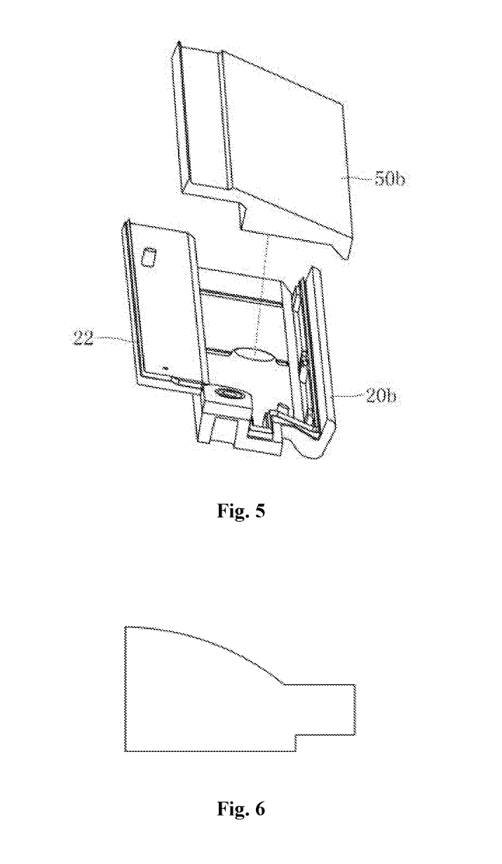

As shown in FIG. 3 and FIG. 5 together, the material and manufacturing process of the sound absorbing material 50b in the present embodiment is the same as that of the sound absorbing material 50a (as shown in FIG. 1) in Embodiment 1, with the exception that the shape of the sound absorbing material 50b is different from that of the sound absorbing material 50a.

As shown in FIG. 3 and FIG. 5 together, the filled region of the rear acoustic cavity in the present embodiment has an irregular-shaped structure, wherein two grooves extending upwardly are provided at the upper end of the filled region, and each the two grooves is a triangular groove which has a relatively wide opening and a sharp bottom, as shown by part A and part B in FIG. 3; the lower end of the filled region has a stepped structure, and a groove extending downwardly is provided at the edge of one side of the stepped structure, and the groove is also a triangular groove which has a relatively wide opening and a sharp bottom, as shown by part C in FIG. 3. The sound absorbing material 50b has the same structure as that of the filled region, and the sound absorbing material 50b fills the entire filled region and fills the bottoms of the triangular grooves as well.

As shown in FIG. 3 and FIG. 5 together, a ultrasonic wire 22 is arranged on the second housing 20b at the position where the second housing 20b and the first housing 10b are bonded, and the first housing 10b and the second housing 20b are hermetically combined by ultrasonic.

The present embodiment is different from Embodiment 1 only in the structure of the speaker module, and the technical problems sought to be solved, the technical solutions utilized for solving the technical problems and the technical effects obtained by the technical solutions are the same as that of Embodiment 1, thus Embodiment 1 and Embodiment 2 possess unity.

In this specification, the above two embodiments are only provided for illustrating the technical solution that the sound absorbing material provided by the present invention is made of a foaming material and is formed by a foaming process. In practical application, the technical solution can be applied in any one of the speaker modules with a sound absorbing material arranged in the rear acoustic cavities thereof, which can be achieved by those skilled in the art according to the description in this specification without inventive effort. Therefore, specific embodiments about the application of the technical solution in other speaker modules with different structures will not be described in detail. Besides, products which have sound absorbing materials in the rear acoustic cavities made of foaming materials and formed by a foaming process fall into the scope of the present invention, regardless of whether a speaker module and a speaker unit accommodated therein are the same to those of above embodiments in structure.

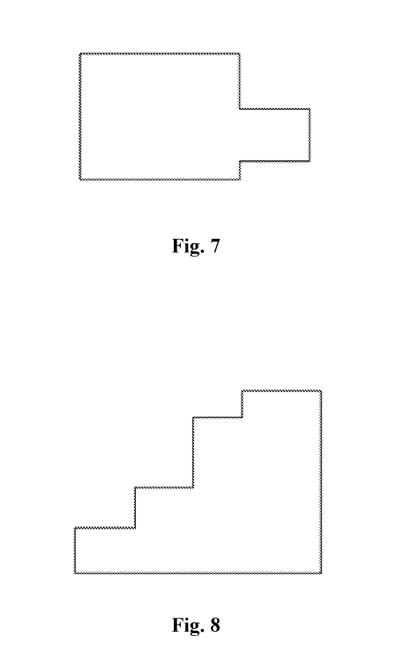

The sound absorbing material made of a foaming material has a structure which is not limited to the structures described in the above two embodiments, which enables sound absorbing materials with different structure perfectly fitting rear acoustic cavities of modules to be processed according to different structures of rear acoustic cavities of the modules. As shown in FIG. 6, one side of the sound absorbing material is a stepped surface and the other side is an arc surface. As shown in FIG. 7, both sides are stepped surfaces. As shown in FIG. 8, one side is a stepped surface, and the other side is a plane surface.

The terms of “first housing”, “second housing” and “third housing” mentioned in Embodiment 1 of the present invention are only used for distinguishing technical features, and have nothing to do with installation sequence, operation sequence and location relationships of the three housings.

The terms of “first housing” and “second housing” mentioned in Embodiment 2 of the present invention are only used for distinguishing technical features, and have nothing to do with installation sequence, operation sequence and location relationship of the two housings.

The present invention is not limited to the above specific embodiments, and various variations made by those skilled in the art according to the above conceptions without inventive effort fall into the protection scope of the present invention.

1. A speaker module, comprising a housing in which a speaker unit is accommodated, wherein the speaker unit comprises a vibration system and a magnetic circuit system, an interior cavity of the speaker module is divided into a front acoustic cavity and a rear acoustic cavity by the speaker unit, and a sound absorbing material is provided in the rear acoustic cavity, wherein a partition member for isolating the sound absorbing material from the speaker unit is provided in the rear acoustic cavity, the rear acoustic cavity is divided into a filled region and a non-filled region by the partition member; the sound absorbing material is located in the filled region, the sound absorbing material is made of foaming material, the sound absorbing material is formed by foaming the foaming material, and the sound absorbing material fills up the filled region.

2. The speaker module according to claim 1, wherein the partition member is provided with a hole which allows airflow to flow between the filled region and the non-filled region.

3. The speaker module according to claim 2, wherein the partition member has a netted structure.

4. The speaker module according to claim 1, wherein the foaming material is PU, DWT, or melamine.

5. The speaker module according to claim 4, wherein the foaming material is foamed through heating process, ultrasonic process or infrared radiation process to form the sound absorbing material.

6. The speaker module according to claim 1, wherein the housing comprises a first housing, a second housing, and a third housing which are combined together, the rear acoustic cavity is defined by the speaker unit, the second housing and the third housing, and the partition member is vertically provided between the second housing and the third housing.

7. The speaker module according to claim 6, wherein a cross section of the filled region has a Chinese character “ [symbol] ”-like shape, that is, a height of a middle part of the cross section is higher than heights of both sides of the cross section; the sound absorbing material has a shape corresponding to that of the filled region, and the sound absorbing material fills up the filled region.

8. The speaker module according to claim 7, wherein the magnetic circuit system comprises a yoke fixed on the second housing, an inner magnet and an inner washer are sequentially arranged at a middle part of an interior side of the yoke, an outer magnet and an outer washer are sequentially arranged at an edge part of the interior side of the yoke, a locating recess formed by material removal is provided at one side of the outer washer closer to the second housing, an interior wall of the second housing is provided with a locating boss at a position opposite to the locating recess, and the locating boss is coupled with the locating recess.

9. The speaker module according to claim 1, wherein the housing comprises a first housing and a second housing which are combined together, the rear acoustic cavity is defined by the speaker unit, the first housing and the second housing, and the partition member is vertically provided between the first housing and the second housing.

10. The speaker module according to claim 9, wherein grooves respectively extending upwardly and downwardly are provided at an upper end and a lower end of the filled region, respectively, each of the grooves is a triangular groove which has a relatively wide opening and a sharp bottom, the sound absorbing material has a shape corresponding to that of the filled region, and the sound absorbing material fills up all of the grooves.

11. The speaker module according to claim 1, wherein the foaming material is solid material, and the rear acoustic cavity is sealed after the foaming material is placed in the filled region.

12. The speaker module according to claim 1, wherein the foaming material is liquid material, and the foaming material is injected into the filled region through an injecting hole of the rear acoustic cavity after the rear acoustic cavity is sealed.
